(19) United States
(12) Patent Application Publication
(10) Pub. No.: US 2013/0141661 A1
(43) Pub. Date: Jun. 6, 2013

(54) Liquid Crystal Display and A Broken Line Repairing Method

(71) Applicants: Liangchan Liao, Shenzhen (CN); Poshen Lin, Shenzhen (CN); Nianmao Wang, Shenzhen (CN)

(72) Inventors: Liangchan Liao, Shenzhen (CN); Poshen Lin, Shenzhen (CN); Nianmao Wang, Shenzhen (CN)

(21) Appl. No.: 13/379,116

(22) PCT Filed: Dec. 7, 2011
(86) PCT No.: PCT/CN11/83612

§ 371 Date: Dec. 19, 2011

(30) Foreign Application Priority Data
Dec. 2, 2011 (CN) 2011103961613

(51) Int. Cl. G02F 1/1333

(52) U.S. Cl. 349/54

(57) ABSTRACT

The present invention discloses a liquid crystal display (LCD) and a broken line repairing method. The LCD comprises multiple data lines, a data driven chip connected to the data lines, and a sequence control circuit connected to the data driven chip. The LCD is provided with at least one broken data line; the broken data line is provided with connection points on the end away from the data driven chip; and each connection point is connected and conducted to a vacant channel of the data driven chip and simultaneously transmits data information of the broken data line to the corresponding vacant channel to be output. The method can drive the data lines on both sides of the breakpoint and does not require an additional OP buffer. A repairing line need not to be reserved on PCBA; and one broken line only has one welding spot, which decreases the production procedure, increases the yield rate of TFT-LCD, and reduces the material and production cost.

### TECHNICAL FIELD

The present invention relates to the field of liquid crystal display, in particular to a liquid crystal display (LCD) and a broken line repairing method.

### BACKGROUND

In the process of producing a TFT-LCD panel, a broken data line appears in the panel because of production. After the panel is electrified, an obvious bright line (or dark line) appears on the panel. The defect cannot be accepted by consumers; i. e. the panel cannot be sold directly. However, if the panel is discarded directly, much waste is caused. Usually, if few broken lines appear, a method shown in FIG. 1 is used: as shown in dashes of FIG. 1, connect a data driven (SD) output channel of the corresponding broken line to PCBA by laser line welding; pass through an OP buffer, and then pass through a reserved test line in the panel to the other side of the panel; then conduct the test line and the other section of the broken line by laser line welding; and charge the test line to display the other section of the broken line. With this method, the linear defect becomes point defect which cannot cause much influence on LCD display performance. However, because the line is connected to PCBA with the line repairing method, the length of the data line is increased obviously; and RC loading of the line is increased. Therefore, an OP buffer is added in PCBA to drive the broken line. The method requires a reserved test line and an additional OP buffer, so the hardware cost is increased. Due to increased procedures, the production cost is high.

### SUMMARY

The aim of the present invention is to provide an LCD and a broken line repairing method with a simplified structure and low cost.

The aim of the present invention is achieved by the following technical schemes.

An LCD comprises multiple data lines, a data driven chip connected to the data lines, and a sequence control circuit connected to the data driven chip. The LCD is provided with at least one broken data line; the broken data line is provided with connection points on the end away from the data driven chip; and each connection point is connected and conducted to a vacant channel of the data driven chip.

Preferably, the broken data line is connected to the nearest data driven chip provided with a vacant channel. Connection to the nearest data driven chip can shorten the length of the data line as much as possible, reduce the RC loading of the line, and ensure that the vacant channel has sufficient driving power to drive the broken data line.

Preferably, the sequence control circuit includes a memory device; the memory device stores position information of the broken data line and the vacant channel of the corresponding driven chip. This is one specific embodiment for repairing the broken line.

A broken line repairing method for the LCD, when the broken data line of the LCD is detected, the method for repairing the data line includes the following steps:

A: Look for the broken data line.

B: Select the vacant channel of the data driven chip; connect the end of the broken data line away from the data driven chip to the vacant channel of the data driven chip.

C: Simultaneously transmit data information of the broken data line to the corresponding vacant channel to be output.

Preferably, in step B, connect the broken data line to the nearest data driven chip with a vacant channel in accordance with the position of the broken data line. Connection to the nearest data driven chip can shorten the length of the data line as much as possible, reduce the RC loading of the line, and ensure that the vacant channel has sufficient driving power to drive the broken data line.

Preferably, the sequence control circuit stores position information of the broken data line and the vacant channel of the corresponding driven chip; in step C, the sequence control circuit simultaneously transmits data information of the broken data line to the corresponding vacant channel to be output in accordance with the stored position information. By using the sequence control circuit to control, no additional control circuit is required; and this embodiment is simple.

Preferably, the sequence control circuit includes EEPROM; position information of the broken data line and the corresponding vacant channel is stored in EEPROM; in step C, the sequence control circuit transmits data information of the broken data line to the corresponding vacant channel to be output in accordance with position information stored in EEPROM. This is one specific embodiment; no additional memory device is required.

Preferably, data information of the broken data line is also stored in EEPROM; in step C, the sequence control circuit reads the position information and the corresponding data information stored in EEPROM to simultaneously transmit the data information of the broken data line to the corresponding vacant channel to be output. This is another specific embodiment.

Preferably, position information of the broken data line and the vacant channel of the corresponding driven chip is downloaded to EEPROM in advance by a computer.

The present invention transmits data information of the broken data line to the corresponding vacant channel to be output by connecting the end of the broken data line away from the data driven chip to the vacant channel of the data driven chip, so that the data lines on both sides of the breakpoint can be driven. In the method, the distance between the data driven chip and the broken data line is short; the vacant channel of the data driven chip has sufficient driving power to drive the broken data line; no additional OP buffer is required; no reserved repairing line is required on PCBA; and one broken line only has one welding point, which decreases the production procedure, increases the yield rate of TFT-LCD, and reduces the material and production cost.

### DESCRIPTION OF FIGURES

FIG. 1 is the functional block diagram of the broken line repairing method in the prior art.

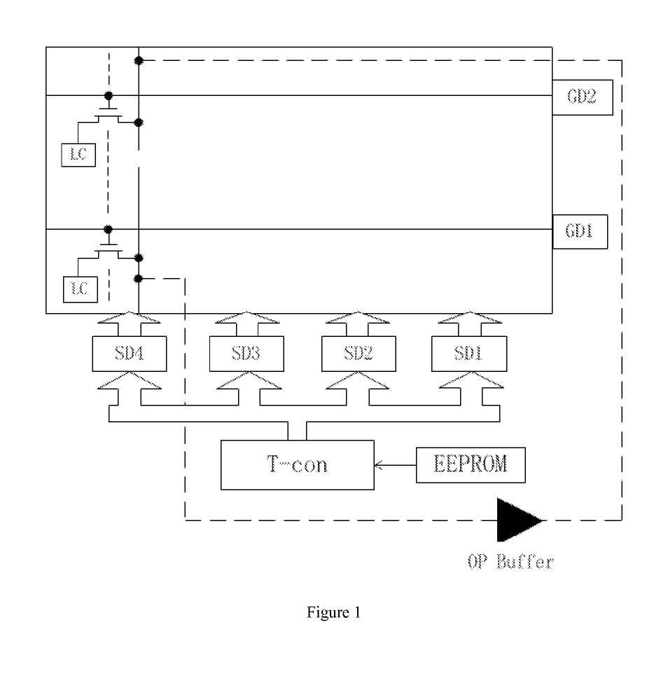

FIG. 2 is the functional block diagram of the present invention by using the vacant channel of the data driven chip on one end of an array substrate to drive the broken line.

FIG. 3 is the functional block diagram of the present invention by using the vacant channel of the data driven chip on the other end of the array substrate to drive the broken line.

FIG. 4 is the functional block diagram of the present invention by using a downloading board to download position information to EEPROM.

Wherein: 1. array substrate, 2. welding spot.

T-con: sequence control circuit

OP Buffer

SD: data driven chip

GD: grid driven chip

LC: liquid crystal pixel electrode

### DETAILED DESCRIPTION

The present invention is further described by figures and the preferred embodiments as follows.

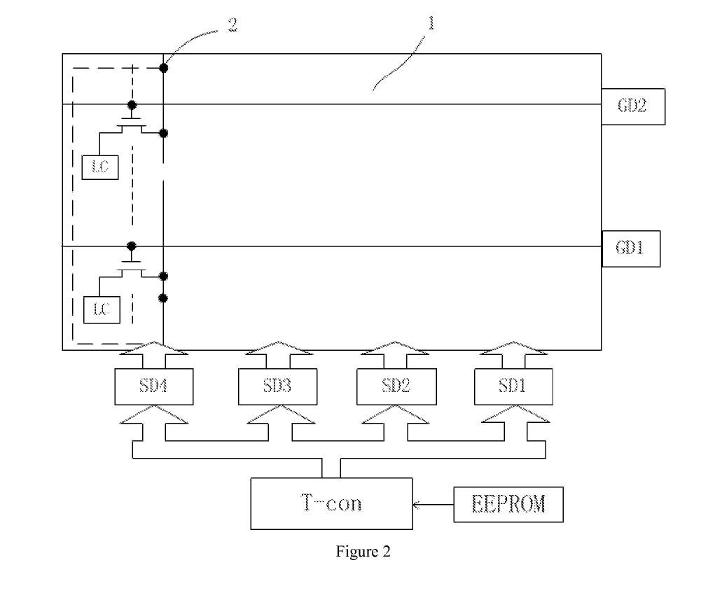

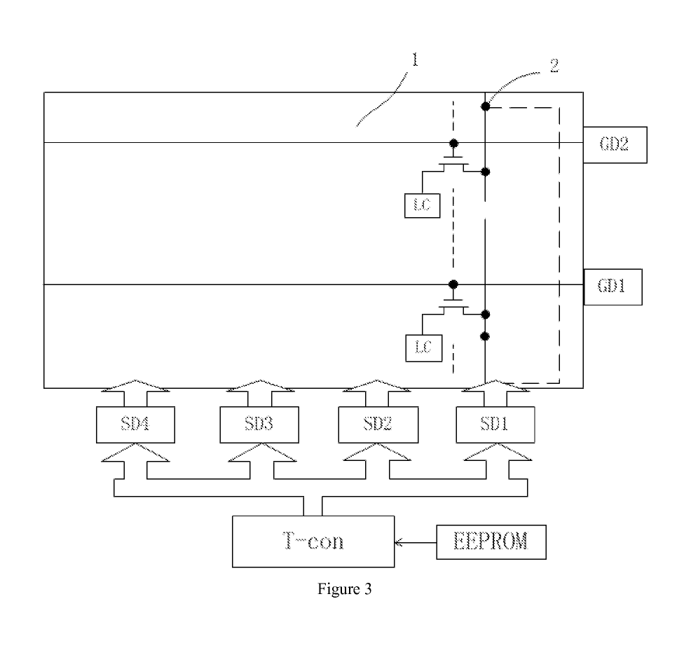

As shown in FIG. 2 and FIG. 3, the liquid crystal display includes an array substrate 1. The array substrate 1 includes multiple data lines and grid lines; the data lines are connected to the data driven chip; and the grid lines are connected to the grid driven chip. The grid lines control the conduction of TFT (thin-film transistor). The data lines are connected to the source electrode of TFT. When TFT is conducted, level signals of the data lines are connected to the drain electrode of TFT to drive the liquid crystal pixel electrode (LC) to display correspondingly. The grid scanning chip and the data driven chip are connected to the sequence control circuit. The sequence control circuit converts the displayed image information to the level signals to control the data driven chip and the grid driven chip to scan correspondingly.

The array substrate 1 at least has one broken data line; the broken data line has connection points (welding spot 2 caused by welding) on the end away from the data driven chip; and each connection point is connected and conducted to a vacant channel of the data driven chip. Generally, the data driven chip with a vacant channel is located on both ends of the array substrate 1 as shown in SD1 and SD4. If the broken line appears on the left end, the welding spot 2 is connected to SD4. If the broken line appears on the right end, the welding spot 2 is connected to SD1. Connection of the welding spot 2 to the nearest data driven chip can shorten the length of the data line as much as possible, reduce the RC loading of the line, and ensure that the vacant channel has sufficient driving power to drive the broken data line.

The broken line repairing method for LCD includes the following steps:

A: Look for the broken data line; and use detection equipment to position the broken data line.

B: Select the vacant channel of the data driven chip; connect the end of the broken data line away from the data driven chip to the vacant channel of the data driven chip; and connect the vacant channel to the end of the broken data line away from the data driven chip for welding in the way of laser line welding.

C: Simultaneously transmit data information (i. e. a voltage signal) of the broken data line to the corresponding vacant channel to be output.

Position information of the broken data line and the corresponding vacant channel can be stored in EEPROM of the sequence control circuit. When the display is electrified, the sequence control circuit automatically reads the position information in EEPROM and then simultaneously transmits the data information of the broken data line to the corresponding vacant channel and the original channel of the broken data line to be output. The corresponding data information of the broken data line can be copied to be stored in EEPROM together with the corresponding data information of all original channels.

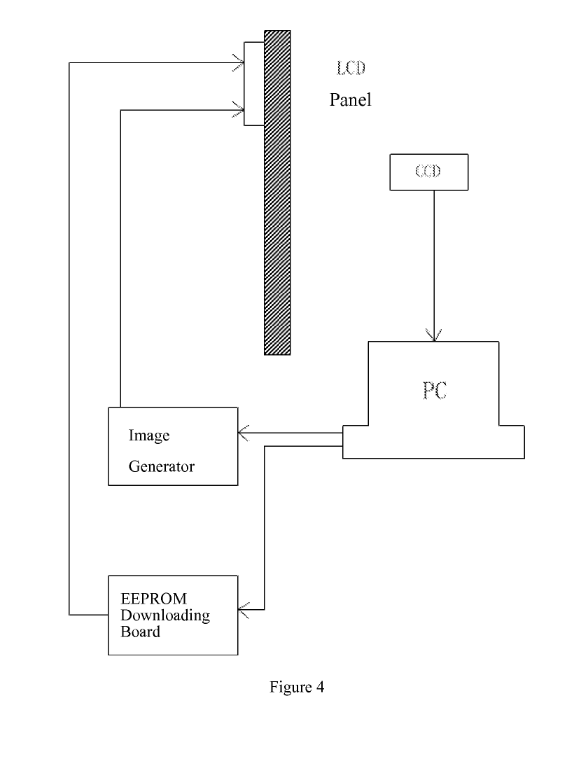

As shown in FIG. 4, position information of the broken data line and the corresponding vacant channel is downloaded to EEPROM in advance by the EEPROM downloading board controlled by the computer. Generally, the detection equipment is controlled by the computer; the computer receives a signal from a CCD image sensor; and the LCD is examined for a broken line by connecting an image generator to the LCD. If there is a broken line, record corresponding data information of the broken line; and then download position information of the broken data line and the corresponding vacant channel to EEPROM by the EEPROM downloading board. The method has the advantages of simple operation and high degree of automation, and can increase production efficiency and reduce production cost.

In the broken line repairing method, the distance between the data driven chip and the broken data line is short; the vacant channel of the data driven chip has sufficient driving power to drive the broken data line; no additional OP damper is required; no reserved repairing line is required on PCBA; and one broken line only has one connection point for welding, which decreases the production procedure, increases the yield rate of TFT-LCD, and reduces the material and production cost.

The present invention is described in detail in accordance with the above contents with the specific preferred embodiments. However, this invention is not limited to the specific embodiments. For the ordinary technical personnel of the technical field of the present invention, on the premise of keeping the concept of the present invention, the technical personnel can also make simple deductions or replacements, and all of which should be considered to belong to the protection scope of the present invention.

We claim:

1. A liquid crystal display (LCD), comprising: multiple data lines, a data driven chip connected to the data lines, and a sequence control circuit connected to the data driven chip; said LCD is provided with at least one broken data line; said broken data line is provided with connection points on the end away from the data driven chip; and each connection point is connected and conducted to a vacant channel of the data driven chip.

2. The LCD of claim 1, wherein said broken data line is connected to the nearest data driven chip provided with a vacant channel.

3. The LCD of claim 1, wherein said sequence control circuit includes a memory device; said memory device stores position information of the broken data line and the vacant channel of the corresponding driven chip.

4. A broken line repairing method for said LCD of claim 1, including the following steps:
A: look for the broken data line;
B: select the vacant channel of the data driven chip; connect the end of the broken data line away from the data driven chip to the vacant channel of the data driven chip;
C: simultaneously transmit data information of the broken data line to the corresponding vacant channel to be output.

5. The broken line repairing method for LCD of claim 4, wherein in step B, connect the broken data line to the nearest data driven chip with a vacant channel in accordance with the position of the broken data line.

6. The LCD broken line repairing method of claim 4, wherein said sequence control circuit stores position information of the broken data line and the vacant channel of the corresponding driven chip; in step C, said sequence control circuit simultaneously transmits data information of the broken data line to the corresponding vacant channel to be output in accordance with the stored position information.

7. The LCD broken line repairing method of claim 6, wherein said sequence control circuit includes EEPROM; position information of the broken data line and the corresponding vacant channel is stored in EEPROM; in step C, said sequence control circuit transmits data information of the broken data line to the corresponding vacant channel to be output in accordance with position information stored in EEPROM.

8. The broken line repairing method for LCD of claim 7, wherein data information of the broken data line is also stored in EEPROM; in step C, said sequence control circuit reads the position information and the corresponding data information stored in EEPROM to simultaneously transmit the data information of the broken data line to the corresponding vacant channel to be output.

9. The LCD broken line repairing method of claim 7, wherein position information of the broken data line and the vacant channel of the corresponding driven chip is downloaded to EEPROM in advance by a computer.
